(19) United States
(12) Patent Application Publication
(10) Pub. No.: US 2024/0105064 A1
(43) Pub. Date: Mar. 28, 2024

(54) UNMANNED AERIAL VEHICLE-AIDED OVER-THE-AIR COMPUTING SYSTEM BASED ON FULL-DUPLEX RELAY AND TRAJECTORY AND POWER OPTIMIZATION METHOD THEREOF

(71) Applicant: China University of Mining and Technology, Xuzhou (CN)

(72) Inventors: Song LI, Xuzhou (CN); Yanjing SUN, Xuzhou (CN); Bowen WANG, Xuzhou (CN); Yu ZHOU, Xuzhou (CN); Xiao YUN, Xuzhou (CN); Ruirui CHEN, Xuzhou (CN); Jiaqi LI, Xuzhou (CN)

(21) Appl. No.: 18/124,751

(22) Filed: Mar. 22, 2023

Related U.S. Application Data
(63) Continuation of application No. PCT/CN2022/105164, filed on Jul. 12, 2022.

(30) Foreign Application Priority Data
Dec. 16, 2021 (CN) CN202111561590.1

(51) Int. Cl. G08G 5/00

(52) U.S. Cl. CPC G08G 5/003; G08G 5/0013

(57) ABSTRACT

Disclosed is an unmanned aerial vehicle (UAV)-aided over-the-air computing system based on full-duplex relay and a trajectory and power optimization method thereof. The UAV-aided over-the-air computing system adopts the UAV as a full-duplex relay for data fusing and forwarding. The method of the application aims at minimizing an average mean square error of over-the-air computing, and solves an optimization problem under constraints of sensor transmitting power, information transmission rate, UAV trajectory and denoising factor. For an overall joint optimization problem, each optimization variable is determined one by one by an alternative optimization method according to the high coupling of optimization variables.

### CROSS-REFERENCE TO RELATED APPLICATIONS

This application is a continuation of PCT/CN2022/105164, filed on Jul. 12, 2022, which claims priority to Chinese Patent Application No. 202111561590.1, filed on Dec. 16, 2021, the contents of which are hereby incorporated by reference.

### TECHNICAL FIELD

The present application relates to an unmanned aerial vehicle (UAV)-aided over-the-air computing system and a trajectory and power optimization method thereof, and in particular to a UAV-aided over-the-air computing system based on full-duplex relay and a trajectory and power optimization method.

### BACKGROUND

Due to the advantages of strong mobility, flexible configuration and line-of-sight link, Unmanned Aerial Vehicle (UAV) is widely used in the field of wireless communication. UAV can also move to a place close enough to the sensor in the harsh field, which avoids long-distance information transmission, saves the power of the sensor and mitigates the influence of noise. In the air-to-ground transmission, the UAV is high in altitude and has usually a line-of-sight wireless transmission with the sensor, so the probability of channel depth fading is reduced. Because sensors and base stations can't communicate directly, using UAV as relay has become an important research direction of information collection in the Internet of Things based on UAV.

In 2021, in “UAV-assisted over-the-air computation” published by Min Fu et al., it is proposed to use high mobility and wireless line-of-sight transmission capability of UAV to assist the over-the-air computing system, so as to minimize the mean square error of over-the-air computing. In this system, UAV receives the information from sensors through the fusion of airborne base stations, and transmits and fuses the data of multiple sensors in a single time slot. However, in the wireless sensor network under complex environment, there is no direct communication between sensors and base stations.

### SUMMARY

The objective of the present application is to provide an unmanned aerial vehicle (UAV)-aided over-the-air computing system based on full-duplex relay which realizes direct communication between sensors and a base station and a trajectory and power optimization method thereof.

The UAV-aided over-the-air computing system includes one base station, one UAV and multiple sensors placed on the ground.

The base station receives information from the UAV; the multiple sensors transmit information to the UAV at the same time.

As a full-duplex relay, the UAV works in a Fusion and Forward (FF) mode, receiving fused information transmitted by the multiple sensors and transmitting the information to the base station at the same time.

The UAV collects and fuses data of the sensors in a way of over-the-air computing, and forwards the data to the base station in a way of full-duplex relay; the UAV flies according to an optimized flight trajectory.

A trajectory and power optimization method of the application includes following steps:
S1, establishing a coordinate system with an initial position of UAV flight as an origin, jointly optimizing sensor transmitting power, UAV flight trajectory and denoising factor under constraints of transmitting power of the sensors and the UAV and information transmission rate, establishing an optimization problem with an aim at minimizing an time average mean square error of the over-the-air computing system and decomposing the optimization problem into a denoising factor η[n] optimization sub-problem, a sensor transmitting power pₖ[n] optimization sub-problem, a UAV transmitting power P[n] optimization sub-problem, UAV flight position q[n] optimization sub-problem;
S2, solving each optimization sub-problem step by step by adopting an iterative optimization algorithm; and
S3, obtaining optimal denoising factor η[n], sensor transmitting power pₖ[n], UAV transmitting power P[n] and UAV flight position q[n] according to the S2.

Optionally, in the S1, the optimization problem is established in the coordinate system, and an expression of the optimization problem is:

$$problem 1 {min}_{( {p}_{k} [ n ] , P [ n ] , q [ n ] , η [ n ] )} \overline{MSE} = \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ 1 [ n ] - {w}_{k} ‖}_{2}^{2} )}^{\frac{α}{4}}} - 1 )}^{2} + \frac{{β}_{u}^{2} P [ n ] {β}_{0}}{η [ n ] {L}^{α}} + \frac{{σ}^{2}}{η [ n ]} )$$

$$s . t . 0 \leq {p}_{k} [ n ] \leq {P}_{k} , ∀ k , ∀ n$$

$$0 \leq \frac{1}{N} {\sum }_{n = 1}^{N} {p}_{k} [ n ] \leq \overline{{P}_{k}} , ∀ k$$

$$η [ n ] \geq 0$$

$${‖ q [ n ] - q [ n - 1 ] ‖}_{2} \leq {V}_{max} δ , n = 1 , 2 , … N$$

$$q [ 0 ] = [ {x}_{0} , {y}_{0} ]$$

$$q [ N ] = [ {x}_{N} , {y}_{N} ]$$

$$B {log}_{2} ( 1 + \frac{P [ n ] {β}_{0}}{( {H}^{2} + {‖ q [ n ] - w ‖}_{2}^{2} ) {σ}^{2}} ) \geq {G}_{min}$$

where M̅S̅E̅ is the time average mean square error of the over-the-air computing system of the UAV and is related to pₖ[n], P[n], q[n], and η[n], pₖ[n] is transmitting power of the sensors k in time slots n, P[n] is the UAV transmitting power in the time slots n, q[n] is UAV flight position in the time slots n, η[n] is denoising factor in the time slots n; wₖ is fixed horizontal position of the sensors, w is horizontal position of the base station, β₀ is channel gain per unit distance, σ² is additive white Gaussian noise power, βᵤ is self-interference cancellation coefficient, L is distance from a sending end to a receiving end of the UAV, H is the lowest flight altitude at which the UAV does not need to ascend and descend in flight, Gₘᵢₙ is minimum information transmission rate between the UAV and the base station (BS), α is path loss index and α≥2, N is the number of time slots of duration T, T=Nδ, where δ denotes time step; and Vₘₐₓ is maximum flight speed of the UAV.

Optionally, in the S1, an expression of the denoising factor optimization sub-problem is:

$$\begin{matrix}problem2 & \\ {minimize}_{η [ n ] \geq 0} {\sum }_{n ∈ N} ( {\sum }_{k ∈ K} {( \frac{\sqrt{{p}_{k} [ n ]} \vert {h}_{k} [ n ] \vert}{\sqrt{η [ n ]}} - 1 )}^{2} + \frac{{β}_{u}^{2} P [ n ] {β}_{0}}{η [ n ] {L}^{α}} + \frac{{σ}^{2}}{η [ n ]} ) . & \end{matrix}$$

When the denoising factor η[n] is optimized, it is necessary to give the transmitting power pₖ[n] of the sensors k, the UAV transmitting power P[n] and the UAV flight trajectory q[n].

Optionally, in the S1, an expression of the sensor transmitting power optimization sub-problem is:

$$\begin{matrix}problem3 & \\ {minimize}_{{p}_{k} [ n ]} {\sum }_{n ∈ N} ( {\sum }_{k ∈ K} {( \frac{\sqrt{{p}_{k} [ n ]} \vert {h}_{k} [ n ] \vert}{\sqrt{η [ n ]}} - 1 )}^{2} ) & \end{matrix}$$

$$\begin{matrix}subject to 0 \leq {p}_{k} [ n ] \leq {P}_{k} , ∀ k , ∀ n , \\ 0 \leq \frac{1}{N} {\sum }_{n = 1}^{N} {p}_{k} [ n ] \leq \overline{{P}_{k}} , ∀ k .\end{matrix}$$

When the transmitting power pₖ[n] of sensors k is optimized, it is necessary to give the denoising factor η[n], the UAV transmitting power P[n] and the UAV flight position q[n].

Optionally, an expression of the UAV transmitting power optimization sub-problem is:

$$\begin{matrix}problem4 & \\ {minimize}_{P [ n ]} {\sum }_{n ∈ N} P [ n 1 ( \frac{{β}_{u}^{2} P [ n ] {β}_{0}}{η [ n ] {L}^{a}} ) & \end{matrix}$$

$$subject to B {log}_{2} ( 1 + \frac{P [ n ] {β}_{0}}{( {H}^{2} + {‖ q [ n ] - w ‖}_{2}^{2} ) {σ}^{2}} ) \geq {G}_{min} .$$

When the UAV transmitting power P[n] is optimized, it is necessary to give the denoising factor η[n], the transmitting power pₖ[n] of the sensors k and the UAV flight position q[n].

Optionally, in the S1, the UAV flight trajectory optimization sub-problem is optimized by adopting a convex optimization method, and an expression of the UAV flight trajectory optimization sub-problem:

$$\begin{matrix}problem5 & \\ {minimize}_{q [ n ]} \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ q [ n ] - {w}_{k} ‖}_{2}^{2} )}^{\frac{a}{4}}} - 1 )}^{2} ) & \end{matrix}$$

$$\begin{matrix}subject to {‖ q [ n ] - q [ n - 1 ] ‖}_{2} \leq {V}_{max} δ , n = 1 , 2 , … N \\ q [ 0 ] = [ {x}_{0} , {y}_{0} ] \\ q [ N ] = [ {x}_{N} , {y}_{N} ] \\ B {log}_{2} ( 1 + \frac{P [ n ] {β}_{0}}{( {H}^{2} + ‖ q [ n ] - w {‖}_{2}^{2} ) {σ}^{2}} ) \geq {G}_{min} .\end{matrix}$$

When the UAV flight position q[n] is optimized, it is necessary to give the denoising factor η[n], the transmitting power pₖ[n] of the sensors k and the UAV transmitting power P[n].

Optionally, the S2 is realized as follows:
S21, setting λ as desired accuracy, setting initial iteration times r=0 and reference mean square error R⁰=1;
S22, initializing the transmitting power pₖ⁰[n] of the sensors k, the UAV transmitting power P⁰[n] and an initial flight trajectory q⁰[n] of the UAV;
S23, increasing iteration times r=r+1;
S24, solving the problem2 based on UAV trajectory q^{r-1}[n] of a previous iteration, sensor transmitting power pₖ^{r-1}[n] of a previous iteration and UAV transmitting power P^{r-1}[n] of a previous iteration to obtain denoise factors η^{r}[n];
S25, solving the problem3 based on the UAV trajectory q^{r-1}[n] of the previous iteration, the denoising factor η^{r}[n] obtained in the S24 and the UAV transmitting power P^{r-1}[n] of the previous iteration to obtain sensor transmitting power pₖ^{r}[n];
S26, solving the problem4 based on the UAV trajectory q^{r-1}[n] of the previous iteration, the denoise factor η^{r}[n] obtained in the S24 and the sensor transmitting power pₖ^{r}[n] obtained in the S25 to obtain UAV transmitting power P^{r}[n];
S27, solving the problem5 based on the denoising factor η^{r}[n] obtained in the S24, the sensor transmitting power pₖ^{r}[n] obtained in the S25 and the UAV transmitting power P^{r}[n] obtained in the S26 to obtain UAV trajectory q^{r}[n]; and
S28, letting R^{r}=M̅S̅E̅, if (R^{r-1}−R^{r})/R^{r}≤λ, finishing solving, otherwise, going to the S23.

Compared with the prior art, the application has the following remarkable effects: firstly, the application adopts the UAV as the full-duplex relay to receive and fuse all sensor data, estimates an interesting function, and simultaneously transmits the estimated function value of the time slots to the base station, thus realizing the minimum mean square error under the guarantee of communication rate; secondly, in the process of jointly optimizing the UAV trajectory and sensor power, the optimization problem is decomposed into four independent optimization sub-problems, and the UAV trajectory and power are optimized with low complexity algorithm.

### BRIEF DESCRIPTION OF THE DRAWINGS

FIG. 1 is a schematic diagram of a model of an unmanned aerial vehicle (UAV)-aided over-the-air computing system of the present application.

FIG. 2 is a schematic diagram of simulation results of the present application.

### DETAILED DESCRIPTION OF THE EMBODIMENTS

The present application will be further described in detail with reference to the drawings and specific embodiments of the specification.

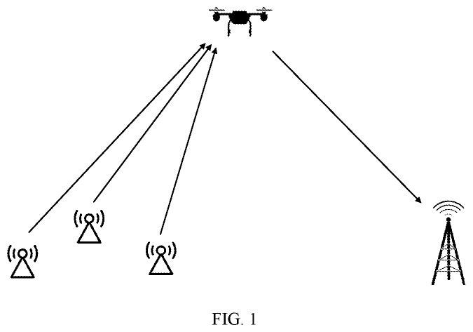

As shown in FIG. 1, an unmanned aerial vehicle (UAV)-aided over-the-air computing system of the present application includes one base station, one UAV and K sensors. The UAV collects and fuses data of sensors on the ground in a way of over-the-air computing and forwards the data to the base station in a way of full-duplex relay. As a full-duplex relay, the UAV works in Fusion and Forward (FF) mode.

A trajectory and power optimization method is realized as follows:
S1, establishing a three-dimensional Cartesian coordinate system with a UAV flight starting point as an origin.

Horizontal coordinates of the sensors k are expressed as wₖ=[xₖ, yₖ]∈□^{1×2}, where xₖ and yₖ represent an abscissa and an ordinate of the sensors, respectively.

The sensor group on the ground is represented as K□{1, 2, . . . K}, K>1, where K is the total number of the sensors.

During the flight of UAV, positions of the sensors on the ground are fixed, and the UAV has stored position information of the sensors. In addition, the UAV flies at a fixed altitude from the ground, denoted as H, a minimum flight altitude to ensure obstacle avoidance without frequent ascending and descending of the UAV. L is a fixed distance between a sending end and a receiving end of the UAV.

A time-varying trajectory of horizontal projection of the UAV is q(t)=[x(t), y(t)]∈□^{1×2}, a starting position q[0]=[x₀, y₀] and an ending position q[T]=[x_{T}, y_{T}], where x₀ and y₀ represent an abscissa and an ordinate of the sensors at an initial position, respectively and x_{T} and y_{T} represent an abscissa and an ordinate of the sensors at ending position, respectively.

A time discretization method is adopted to deal with the continuous UAV trajectory. A duration T of a task is equally divided into N time slots: T=Nδ, where δ is an time step. An appropriate time step is selected so that a distance between the UAV and the sensors is approximately constant in each time slot, that is δVₘₐₓ□H, where the Vₘₐₓ is a maximum flight speed of the UAV. In time slots n, a movement constraint of the UAV in flight is expressed as:

∥q[n]−q[n−1]∥₂≤Vₘₐₓδ,n=1,2, . . . N (1),

q[0]=[x₀,y₀] (2),

q[N]=[x_{N},y_{N}] (3),

where the q[n] is a UAV flight position in the time slots n, and the q[n−1] is a UAV flight position in time slots n−1.

The target of UAV computing is fused data of all sensors on the ground, so a target function ƒ[n] of the UAV computing is expressed as:

$$f [ n ] = ϕ ( {\sum }_{k ∈ K} {ψ}_{k} ( {Z}_{k} [ n ] ) ) , \qquad ( 4 )$$

where the ϕ represents a post-processing function of the UAV, the ψₖ presents a pre-processing function at the sensors k, the Zₖ[n] is data in the time slots n, and q[n] is the UAV flight position.

Pre-processed transmission signals of the sensor are sₖ[n]□ψₖ(Zₖ[n]), and assuming that the transmission signals are independent of each other, they are normalized by zero mean and unit variance, namely: E(sₖ[n])=0, E(sₖ[n]sₖ^{H}[n])=1, E(sᵢ[n]sⱼ[n]^{H})=0, ∀i≠j. Therefore, after post-processing of averaging, a processing function received by the UAV is:

$$f [ n ] = \frac{1}{K} {\sum }_{k ∈ K} {s}_{k} [ n ] . \qquad ( 5 )$$

As the full-duplex relay, the UAV receives data from the sensors in each time slot and sends the data to the base station. A received signal y[n] of the UAV in the time slots n is:

$$y [ n ] = {\sum }_{k ∈ K} {b}_{s k} [ n ] {h}_{s k} [ n ] {s}_{k} [ n ] + {β}_{u} {b}_{u} [ n ] {h}_{u} [ n ] {s}_{u} [ n ] + e [ n ] , \qquad ( 6 )$$

where the sₖ[n] and the sᵤ[n] are transmitted signal of the sensors and transmitted signal at the sending end of the UAV, respectively, the βᵤ is a self-interference cancellation coefficient, the bₛₖ[n] and the bᵤ[n] are transmitted precoding coefficients of sensors k and the UAV, the e[n] represents additive white Gaussian noise, and the hₛₖ[n] and the hᵤ[n] are a channel model of the sensors and the UAV and a channel model of the sending end to the receiving end of the UAV respectively.

A constraint of the transmitting power of the sensors k is:

E(|bₛₖ[n]sₖ[n]|²)=|bₛₖ[n]|²≤Pₖ (7),
where Pₖ is a maximum transmitting power of the sensors. At the same time, Pₖ>0. A constraint of average transmitting power P̅ₖ̅:

P̅ₖ̅≤P (8).

An estimated average value \hat{ƒ}[n] of UAV transmission data is:

$$▯ f [ n ] = \frac{y [ n ]}{K \sqrt{η [ n ]}} , \qquad ( 9 )$$

where η[n] is the denoising factor and K is the total number of the sensors.

Test performance is carried out with mean square error MSE[n], then:

$$\begin{matrix}MSE [ n ] = E [ {\vert \hat{f} [ n ] - f [ n ] \vert}^{2} ] \\ = \frac{1}{K} E [ ( \frac{y [ n ]}{\sqrt{η [ n ]}} - {\sum }_{k ∈ K} {s}_{k} [ n ] ) ] \\ = \frac{1}{{K}^{2}} ( {\sum }_{k ∈ K} {( \frac{{b}_{s k} [ n ] {h}_{s k} [ n ]}{\sqrt{η [ n ]}} - 1 )}^{2} + {( \frac{{β}_{u} {b}_{u} [ n ] {h}_{u} [ n ]}{\sqrt{η [ n ]}} )}^{2} + \frac{{σ}^{2}}{η [ n ]} ) \\ = \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ q [ n ] - {w}_{k} ‖}_{2}^{2} )}^{\frac{α}{4}}} - 1 )}^{2} + \frac{{β}_{u}^{2} P [ n ] {β}_{0}}{η [ n ] {L}^{α}} + \frac{{σ}^{2}}{η [ n ]} )\end{matrix} \qquad ( 10 )$$

where the Wₖ is the fixed horizontal position of the sensors, β₀ is the channel gain per unit distance, βᵤ is the self-interference cancellation coefficient, σ² is the additive white Gaussian noise power, L is the distance from the sending end to the receiving end of the UAV, H is the lowest flight altitude at which the UAV does not need to ascend and descend in flight, and α is the path loss index, α≥2.
S2, solving each optimization sub-problem step by step

Therefore, the following optimization problem problem1 is established:

$$\begin{matrix}problem1 & \\ {min}_{( {p}_{k} [ n ] , P [ n ] , q [ n ] , η [ n ]} \overline{MSE} = \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + ‖ q [ n ] - {w}_{k} {‖}_{2}^{2} )}^{\frac{α}{4}}} - 1 )}^{2} + \frac{{β}_{U}^{2} P [ n ] {β}_{0}}{η [ n ] {L}^{α}} + \frac{{σ}^{2}}{η [ n ]} ) & ( 11 )\end{matrix}$$

$$\begin{matrix}s . t . = 0 \leq {p}_{k} [ n ] \leq {P}_{k} , ∀ k , ∀ n \\ 0 \leq \frac{1}{N} {\sum }_{n = 1}^{N} {p}_{k} [ n ] \leq \overline{{P}_{k}} , ∀ k \\ η [ n ] \geq 0 \\ {‖ q [ n ] - q [ n - 1 ] ‖}_{2} \leq {V}_{1 w x} δ , n = 1 , 2 … N \\ q [ 0 ] = [ {x}_{0} , {y}_{0} ] \\ q [ N ] = [ {x}_{N} , {y}_{N} ] \\ B {log}_{2} ( 1 + \frac{P [ n ] {β}_{0}}{( {H}^{2} + {‖ q [ n ] - w ‖}_{2}^{2} ) {σ}^{2}} ) \geq {G}_{min}\end{matrix}$$

where the Gₘᵢₙ is the minimum information transmission rate between the UAV and the BS (BS: base station), and the B is a communication bandwidth; the pₖ[n] is the transmitting power of the sensors k in time slots n, the P[n] is the UAV transmitting power in time slots n, the UAV flight position in time slots n, and the η[n] is denoising factor in time slots n.

From the optimization problem problem1, it can be seen that optimization variables are highly coupled, so an iterative alternate optimization method is adopted to solve.

Sub-problem 1: when the denoising factor η[n] is optimized, it is necessary to give the transmitting power pₖ[n] of the sensors k, the UAV transmitting power P[n] and the UAV flight position q[n]. At this time, the sub-problem 1 is expressed as:

$$\begin{matrix}problem2 & \\ {minimize}_{η [ n ] \geq 0} {\sum }_{n ∈ N} ( {\sum }_{k ∈ K} ( \frac{\sqrt{{p}_{k} [ n ]} \vert {h}_{k} [ n ] \vert}{\sqrt{η [ n ]}} - 1 ) + \frac{{β}_{u}^{2} P [ n ] {β}_{0}}{η [ n ] {L}^{α}} + \frac{{σ}^{2}}{η [ n ]} ) . & ( 12 )\end{matrix}$$

The optimization problem is decomposed into N sub-problems, and each sub-problem η[n] is optimized to minimize the mean square error of one time slot. Then the n-th sub-problem is expressed as:

$${minimize}_{η [ n ] \geq 0} {\sum }_{k ∈ K} {( \frac{\sqrt{{p}_{k} [ n ]} \vert {h}_{k} [ n ] \vert}{\sqrt{η [ n ]}} - 1 )}^{2} + \frac{{β}_{u}^{2} P [ n ] {β}_{0}}{η [ n ] {L}^{α}} + \frac{{σ}^{2}}{η [ n ]} . \qquad ( 13 )$$

Letting γ[n]=1/\sqrt{η[n]}, the problem represented by formula (13) is transformed into a convex quadratic problem, expressed as:

$${minimize}_{γ [ n ] \geq 0} {\sum }_{k ∈ K} {( \sqrt{{p}_{k} [ n ]} \vert {h}_{k} [ n ] \vert γ [ n ] - 1 )}^{2} + \frac{{β}_{u}^{2} P [ n ] {β}_{0} {γ}^{2} [ n ]}{{L}^{α}} + {σ}^{2} {γ}^{2} [ n ] . \qquad ( 14 )$$

By setting a first derivative of an objective function of formula (14) to zero, the optimal solution is obtained:

$${η}^{*} [ n ] = {( \frac{{σ}^{2} + {β}_{u}^{2} {β}_{0} P [ n ] {L}^{- α} + {\sum }_{k ∈ K} {p}_{k} [ n ] {\vert {h}_{k} [ n ] \vert}^{2}}{{\sum }_{k ∈ K} \sqrt{{p}_{k} [ n ]} \vert {h}_{k} [ n ] \vert} )}^{2} . \qquad ( 15 )$$

Sub-problem 2: when the transmitting power pₖ[n] of the sensors k is optimized, it is necessary to give the denoising factor η[n], the UAV transmitting power P[n] and the UAV flight position q[n]. At this time, the sub-problem 2 is expressed as:

$$\begin{matrix}problem3 & \\ {minimize}_{{p}_{k} [ n ]} {\sum }_{n ∈ N} ( {\sum }_{k ∈ K} ( \frac{\sqrt{{p}_{k} [ n ]} \vert {h}_{k} [ n ] \vert}{\sqrt{η [ n ]}} - 1 ) & ( 16 )\end{matrix}$$

$$\begin{matrix}subject to 0 \leq {p}_{k} [ n ] \leq {P}_{k} , ∀ k , ∀ n , \\ 0 \leq \frac{1}{N} {\sum }_{n = 1}^{N} {p}_{k} [ n ] \leq \overline{{P}_{k}} , ∀ k .\end{matrix}$$

Because both

$$\frac{{β}_{u}^{2} P [ n ] {β}_{0}}{η [ n ] {L}^{α}} and \frac{{σ}^{2}}{η [ n ]}$$

in the objective function are constants, the

$$\frac{{β}_{u}^{2} P [ n ] {β}_{0}}{η [ n ] {L}^{α}}$$

and the

$$\frac{{σ}^{2}}{η [ n ]}$$

are ignored. The sub-problem 2 is decomposed into the following K sub-problems:

$${minimize}_{{p}_{k} [ n ]} {\sum }_{n ∈ N} ( {( \frac{\sqrt{{p}_{k} [ n ]} \vert {h}_{k} [ n ] \vert}{\sqrt{η [ n ]}} - 1 )}^{2} ) \qquad ( 17 )$$

$$\begin{matrix}subject to 0 \leq {p}_{k} [ n ] \leq {P}_{k} , ∀ k , ∀ n , \\ 0 \leq \frac{1}{N} {\sum }_{n = 1}^{N} {p}_{k} [ n ] \leq \overline{{P}_{k}} , ∀ k .\end{matrix}$$

Since formula (17) is a typical convex linear constrained quadratic programming problem, the formula (17) is solved by a standard convex optimization method.

Sub-problem 3: when the UAV transmitting power P[n] is optimized, it is necessary to give the denoising factor η[n], the transmitting power pₖ[n] of the sensors k and the UAV flight position q[n]. At this time, the sub-problem 3 is expressed as:

$$\begin{matrix}problem4 & \\ {minimize}_{P [ n ]} {\sum }_{n ∈ N} ( \frac{{β}_{u}^{2} P [ n ] {β}_{0}}{η [ n ] {L}^{α}} ) & ( 18 )\end{matrix}$$

$$subject to B {log}_{2} ( 1 + \frac{P [ n ] {β}_{0}}{( {H}^{2} + {‖ q [ n ] - w ‖}_{2}^{2} ) {σ}^{2}} ) \geq {G}_{min} .$$

For formula (18), since a constant term is ignored, so the formula (18) is solvable.

Sub-problem 4: when the UAV flight position q[n] is optimized, it is necessary to give the denoising factor η[n], the transmitting power pₖ[n] of the sensors k and the UAV transmitting power P[n]. At this time, the sub-problem 4 is expressed as:

$$\begin{matrix}problem5 & \\ {minimize}_{q [ n ]} \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ q [ n ] - {w}_{k} ‖}_{2}^{2} )}^{\frac{α}{4}}} - 1 )}^{2} ) & ( 19 )\end{matrix}$$

$$\begin{matrix}subject to {‖ q [ n ] - q [ n - 1 ] ‖}_{2} \leq {V}_{max} δ , n = 1 , 2 , … N \\ q [ 0 ] = [ {x}_{0} , {y}_{0} ] \\ q [ N ] = [ {x}_{N} , {y}_{N} ]\end{matrix}$$

$$B {log}_{2} ( 1 + \frac{P [ n ] {β}_{0}}{( {H}^{2} + {‖ q [ n ] - {w}_{k} ‖}_{2}^{2} ) {σ}^{2}} ) \geq {G}_{min} ,$$

$${f}_{k} [ n ] = \frac{{p}_{k} [ n ] {β}_{0} / η [ n ]}{{( {H}^{2} + {‖ q [ n ] - {w}_{k} ‖}_{2}^{2} )}^{\frac{α}{2}}} , \qquad ( 20 )$$

$$subject to {g}_{k} [ n ] = \frac{2 \sqrt{{p}_{k} [ n ]} \sqrt{{β}_{0}} / \sqrt{η [ n ]}}{{( {H}^{2} + {‖ q [ n ] - {w}_{k} ‖}_{2}^{2} )}^{\frac{α}{4}}} , \qquad ( 21 )$$

and the UAV trajectory optimization problem is transformed into:

$${minimize}_{q [ n ]} {\sum }_{n ∈ N} {\sum }_{k ∈ K} ( {f}_{k} [ n ] - {g}_{k} [ n ] ) . \qquad ( 22 )$$

By introducing a relaxation variable s={sₖ[n]=∥q[n]−wₖ∥₂², ∀k, ∀n}, the sub-problem 4 is expressed as:

$${minimize}_{q [ n ] , {s}_{k} [ n ]} {\sum }_{k ∈ K} {\sum }_{n ∈ N} ( \frac{{p}_{k} [ n ] {β}_{0} / η [ n ]}{{( {H}^{2} + {s}_{k} [ n ] )}^{\frac{α}{2}}} - {g}_{k} [ n ] + 1 ) . \qquad ( 23 )$$

According to Taylor's formula, a global lower bound ĝₖ^{lb}[n] is obtained:

$${g}_{k} [ n ] \geq {g}_{k}^{r} [ n ] + {∇}_{q [ n ]} {g}_{k} [ n ] {\vert}_{q [ n ] = {q}^{′} [ n ]} ( {‖ q [ n ] - {w}_{k} ‖}_{2}^{2} - {‖ {q}^{r} [ n ] - {w}_{k} ‖}_{2}^{2} ) □ {\hat{g}}_{k}^{l b} [ n ] , \qquad ( 24 )$$

$$where {∇}_{q [ n ]} {g}_{k} [ n ] {\vert}_{q [ n ] = {q}^{′} [ n ]} = - \frac{α \sqrt{{p}_{k} [ n ]} \sqrt{{β}_{0}} / \sqrt{η [ n ]}}{2 {( {H}^{2} + {‖ {q}^{r} [ n ] - {w}_{k} ‖}_{2}^{2} )}^{\frac{α + 4}{4}}} .$$

An inequality is obtained at the same time:

∥q[n]−wₖ∥₂²≥∥q^{r}[n]−wₖ∥₂²+2(q^{r}[n]−wₖ)^{T}(q[n]−q^{r}[n]) (25).

The sub-problem 4 is further transformed into:

$${minimize}_{q [ n ] , {s}_{k} [ n ]} {\sum }_{k ∈ K} {\sum }_{n ∈ N} ( \frac{{p}_{k} [ n ] {β}_{0} / η [ n ]}{{( {H}^{2} + {s}_{k} [ n ] )}^{\frac{α}{2}}} - {\hat{g}}_{k}^{l b} [ n ] + 1 ) \qquad ( 26 )$$

$$\begin{matrix}subject to {‖ q [ n ] - q [ n - 1 ] ‖}_{2} \leq {V}_{max} δ , n = 1 , 2 , … N \\ q [ 0 ] = [ {x}_{0} , {y}_{0} ] \\ q [ N ] = [ {x}_{N} , {y}_{N} ]\end{matrix}$$

$$B {log}_{2} ( 1 + \frac{P [ n ] {β}_{0}}{( {H}^{2} + {‖ q [ n ] - w ‖}_{2}^{2} ) {σ}^{2}} ) \geq {G}_{min}$$

$${s}_{k} [ n ] \geq 0 \\ {s}_{k} [ n ] \leq {‖ {q}^{r} [ n ] - {w}_{k} ‖}_{2}^{2} + 2 {( {q}^{r} [ n ] - {w}_{k} )}^{T} ( q [ n ] - {q}^{r} [ n ] ) .$$

Therefore, formula (26) transformed from the sub-problem 4 is a Quadratical Constraint Quadratic Programming (QCQP) problem and is solved by the standard convex optimization method. Through continuous iterative solution, the optimal power and UAV trajectory are finally obtained.

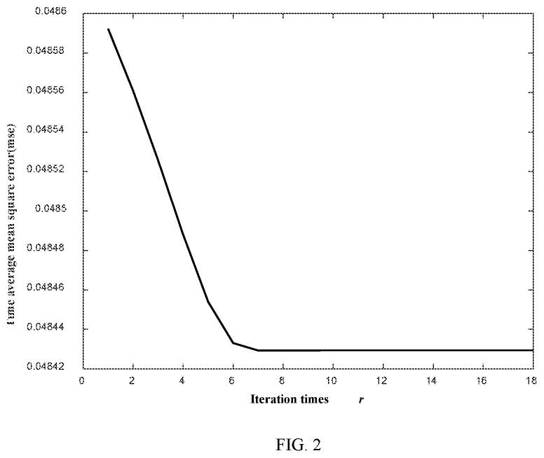

In order to minimize the time average mean square error of the system, the application adopts iterative optimization algorithm to solve each sub-problem step by step, and implementation steps are as follows:
S21, setting λ as desired accuracy, UAV flight time as T, the number of the sensor as K, maximum transmitting power as Pₖ[n] and average transmitting power as P̅ₖ[n], setting initial iteration times r=0 and reference mean square error R⁰=1;
S22, initializing the transmitting power pₖ⁰[n] of the sensors k, the UAV transmitting power P⁰[n] and an initial flight position q⁰[n] of the UAV;
S23, r=r+1;
S24, solving the problem2 based on q^{r-1}[n], pₖ^{r-1}[n] and P^{r-1}[n] to obtain η^{r}[n];
S25, solving the problem3 the q^{r-1}[n], the η^{r}[n] and the P^{r-1}[n] to obtain pₖ^{r}[n];
S26, solving the problem4 based on the q^{r-1}[n], the η^{r}[n] and the pₖ^{r}[n] to obtain P^{r}[n];
S27, solving the problem5 based on the η^{r}[n], the pₖ^{r}[n] and the P^{r}[n] to obtain q^{r}[n];
S28, letting R^{r}=M̅S̅E̅, if (R^{r-1}−R^{r})/R^{r}≤λ, proceeding next step, otherwise, going to the S23; and
S29, solving and outputting η[n], q[n], pₖ[n], P[n].
   The simulation results of the application are as follows.
   The simulation conditions are as follows: UAV flight altitude H=50 m, maximum speed 8 m/s, channel gain β₀=−40 dB, self-interference cancellation coefficient βᵤ=−60 dB, noise power σ²=−80 dBm, and algorithm accuracy λ=10⁻⁴.
   The simulation results are shown in FIG. 2, which shows that the time average mean square error obtained by the method of the application successfully converges after several iterations, which fully demonstrates the effectiveness of the method.
   The simulation results are shown in FIG. 2 and it is shown that the time average mean square error obtained by the method of the application is successfully converged after several iterations, which fully demonstrates the method is effective.

What is claimed is:

1. An unmanned aerial vehicle (UAV)-aided over-the-air computing system based on full-duplex relay, comprising one base station, one UAV and multiple sensors placed on a ground,
wherein the base station receives information from the UAV; and the multiple sensors transmit information to the UAV at a same time;
the UAV works in a fusion and forward mode as a full-duplex relay, receives fused information transmitted by the multiple sensors and transmits the information to the base station at a same time; and
the UAV collects and fuses data of the sensors in a way of over-the-air computing, and forwards the data to the base station in a way of full-duplex relay; and the UAV flies according to an optimized flight trajectory.

2. A trajectory and power optimization method of a UAV-aided over-the-air computing system based on the full-duplex relay, comprising following steps:
S1, establishing a coordinate system with an initial position of UAV flight as an origin, jointly optimizing sensor transmitting power, a UAV flight trajectory and a denoising factor under constraints of transmitting power of sensors and the UAV and an information transmission rate, establishing an optimization problem with an aim at minimizing an time average mean square error of the over-the-air computing system and decomposing the optimization problem into a denoising factor η[n] optimization sub-problem, a sensor transmitting power pₖ[n] optimization sub-problem, a UAV transmitting power P[n] optimization sub-problem, and a UAV flight position q[n] optimization sub-problem;
S2, solving each optimization sub-problem step by step by adopting an iterative optimization algorithm; and
S3, obtaining an optimal denoising factor η[n], the sensor transmitting power pₖ[n], the UAV transmitting power P[n] and the UAV flight position q[n] according to the S2.

3. The trajectory and power optimization method of a UAV-aided over-the-air computing system based on full-duplex relay according to claim 2, wherein in the S1, the optimization problem is established in the coordinate system, and an expression of the optimization problem is:
$$\begin{matrix}problem1 & \\ {min}_{( {p}_{k} [ n ] , P [ n ] , q [ n ] , η [ n ] )} \overline{MSE} & \end{matrix}$$
$$= \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ q [ n ] - {w}_{k} ‖}_{2}^{2} )}^{\frac{a}{4}}} - 1 )}^{2} + \frac{{β}_{u}^{2} P [ n ] {β}_{0}}{η [ n ] {L}^{α}} + \frac{{σ}^{2}}{η [ n ]} )$$
$$s . t . 0 \leq {p}_{k} [ n ] \leq {P}_{k} , ∀ k , ∀ n$$
$$0 \leq \frac{1}{N} {\sum }_{n = 1}^{N} {p}_{k} [ n ] \leq \overline{{P}_{k}} , ∀ k$$
$$η [ n ] \geq 0$$
$${‖ q [ n ] - q [ n - 1 ] ‖}_{2} \leq {V}_{max} δ , n = 1 , 2 … N$$
$$q [ 0 ] = [ {x}_{0} , {y}_{0} ]$$
$$q [ N ] = [ {x}_{N} , {y}_{N} ]$$
$$B {log}_{2} ( 1 + \frac{P [ n ] {β}_{0}}{( {H}^{2} + {‖ q [ n ] - w ‖}_{2}^{2} ) {σ}^{2}} ) \geq {G}_{min} ,$$
wherein M̅S̅E̅ is the time average mean square error of the UAV-aided over-the-air computing system and is related to pₖ[n], P[n], q[n], and η[n], pₖ[n] is the transmitting power of the sensors k in a time slot n, P[n] is the UAV transmitting power in the time slot n, q[n] is UAV flight position in the time slot n, η[n] is the denoising factor in the time slot n; wₖ is a fixed horizontal position of the sensors, w is a horizontal position of a base station, β₀ is a channel gain per unit distance, σ² is an additive white Gaussian noise power, βᵤ is a self-interference cancellation coefficient, L is a distance from a sending end to a receiving end of the UAV, H is a lowest flight altitude not to be ascended and descended in flight by the UAV, Gₘᵢₙ is a minimum information transmission rate between the UAV and the base station (BS), α is a path loss index and α≥2; N is a number of time slots in a duration T, T=Nδ, wherein δ denotes a time step; and Vₘₐₓ is a maximum flight speed of the UAV.

4. The trajectory and power optimization method of a UAV-aided over-the-air computing system based on full-duplex relay according to claim 3, wherein in the S1, an expression of the denoisin factor optimization sub-problem is:
$$\begin{matrix}problem2 & \\ {minimize}_{η [ n ] \geq 0} {\sum }_{n ∈ N} ( {\sum }_{k ∈ K} {( \frac{\sqrt{{p}_{k} [ n ]} \vert {h}_{k} [ n ] \vert}{\sqrt{η [ n ]}} - 1 )}^{2} + \frac{{β}_{u}^{2} P [ n ] {β}_{0}}{η [ n ] {L}^{α}} + \frac{{σ}^{2}}{η [ n ]} ) ; & \end{matrix}$$
when the denoising factor η[n] is optimized, it is necessary to give the transmitting power pₖ[n] of the sensors k, the UAV transmitting power P[n] and the UAV flight trajectory q[n].

5. The trajectory and power optimization method of a UAV-aided over-the-air computing system based on full-duplex relay according to claim 3, wherein in the S1, an expression of the sensor transmitting power optimization sub-problem is:
$$\begin{matrix}problem3 & \\ {minimize}_{{p}_{k} [ n ]} {\sum }_{n ∈ N} ( {\sum }_{k ∈ K} {( \frac{\sqrt{{p}_{k} [ n ]} \vert {h}_{k} [ n ] \vert}{\sqrt{η [ n ]}} - 1 )}^{2} & \end{matrix}$$
$$\begin{matrix}subject to 0 \leq {p}_{k} [ n ] \leq {P}_{k} , ∀ k , ∀ n , \\ 0 \leq \frac{1}{N} {\sum }_{n = 1}^{N} {p}_{k} [ n ] \leq \overline{{P}_{k}} , ∀ k ,\end{matrix} ;$$
when the transmitting power pₖ[n] of sensors k is optimized, it is necessary to give the denoising factor η[n], the UAV transmitting power P[n] and the UAV flight position q[n].

6. The trajectory and power optimization method of a UAV-aided over-the-air computing system based on full-duplex relay according to claim 3, wherein an expression of the UAV transmitting power optimization sub-problem is:
$$\begin{matrix}problem4 & \\ {minimize}_{P [ n ]} {\sum }_{n ∈ N} ( \frac{{β}_{u}^{2} P [ n ] {β}_{0}}{η [ n ] {L}^{α}} ) & \end{matrix}$$
$$subject to B {log}_{2} ( 1 + \frac{P [ n ] {β}_{0}}{( {H}^{2} + {‖ q [ n ] - w ‖}_{2}^{2} ) {σ}^{2}} ) \geq {G}_{min} ;$$
when the UAV transmitting power P[n] is optimized, it is necessary to give the denoising factor η[n], the transmitting power pₖ[n] of the sensors k and the UAV flight position q[n].

7. The trajectory and power optimization method of a UAV-aided over-the-air computing system based on full-duplex relay according to claim 3, wherein in the S1, the UAV flight trajectory optimization sub-problem is optimized by adopting a convex optimization method, and an expression of the UAV flight trajectory optimization sub-problem:
$$\begin{matrix}problem5 & \\ {minimize}_{q [ n ]} \frac{1}{N} {\sum }_{n ∈ N} \frac{1}{{K}^{2}} ( {\sum }_{k ∈ K} {( \frac{\sqrt{{p}_{k} [ n ]} \sqrt{{β}_{0}}}{\sqrt{η [ n ]} {( {H}^{2} + {‖ q [ n ] - {w}_{k} ‖}_{2}^{2} )}^{\frac{α}{4}}} - 1 )}^{2} ) & \end{matrix}$$
$$\begin{matrix}subject to {‖ q [ n ] - q [ n - 1 ] ‖}_{2} \leq {V}_{max} δ , n = 1 , 2 , … N \\ q [ 0 ] = [ {x}_{0} , {y}_{0} ] \\ q [ N ] = [ {x}_{N} , {y}_{N} ]\end{matrix}$$
$$B {log}_{2} ( 1 + \frac{P [ n ] {β}_{0}}{( {H}^{2} + {‖ q [ n ] - w ‖}_{2}^{2} ) {σ}^{2}} ) \geq {G}_{min} ;$$
when the UAV flight position q[n] is optimized, it is necessary to give the denoising factor η[n], the transmitting power pₖ[n] of the sensors k and the UAV transmitting power P[n].

8. The trajectory and power optimization method of a UAV-aided over-the-air computing system based on full-duplex relay according to claim 3, wherein the S2 is realized as follows:
S21, setting λ as desired accuracy, setting initial iteration times r=0 and reference mean square error R⁰=1;
S22, initializing the transmitting power pₖ⁰[n] of the sensors k, the UAV transmitting power P⁰[n] and an initial flight trajectory q⁰[n] of the UAV;
S23, increasing iteration times r=r+1;
S24, solving the problem2 based on UAV trajectory q^{r-1}[n] of a previous iteration, sensor transmitting power pₖ^{r-1}[n] of a previous iteration and UAV transmitting power P^{r-1}[n] of a previous iteration to obtain denoise factors η^{r}[n];
S25, solving the problem3 based on the UAV trajectory q^{r-1}[n] of the previous iteration, the denoising factor η^{r}[n] obtained in the S24 and the UAV transmitting power P^{r-1}[n] of the previous iteration to obtain sensor transmitting power pₖ^{r}[n];
S26, solving the problem4 based on the UAV trajectory q^{r-1}[n] of the previous iteration, the denoise factor η^{r}[n] obtained in the S24 and the sensor transmitting power pₖ^{r}[n] obtained in the S25 to obtain UAV transmitting power P^{r}[n];
S27, solving the problem5 based on the denoising factor η^{r}[n] obtained in the S24, the sensor transmitting power pₖ^{r}[n] obtained in the S25 and the UAV transmitting power P^{r}[n] obtained in the S26 to obtain UAV trajectory q^{r}[n]; and
S28, letting R^{r}=M̅S̅E̅, finishing solving when (R^{r-1}−R^{r})/R^{r}≤λ; otherwise, going to the S23.
